(19) United States
(12) Patent Application Publication
(10) Pub. No.: US 2007/0192795 A1
(43) Pub. Date: Aug. 16, 2007

(54) Method of providing a personalized broadcast service

(75) Inventors: Andreas Kellner, Shigapore (SG); Jan Kneissler, Aachen (DE); Holger R. Scholl, Herzogenrath (DE); Eric Thelen, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,326

(22) PCT Filed: Jan. 18, 2005
(86) PCT No.: PCT/IB05/50200

§ 371 Date: Oct. 31, 2006

(30) Foreign Application Priority Data
Jan. 26, 2004 (EP) 04100269.2

(51) Int. Cl. H04N 5/445; H04N 7/10; H04N 7/025; G06F 3/00

(52) U.S. Cl. 725/46; 725/34; 725/35

(57) ABSTRACT

There is described a method of providing a personalized broadcast service. The method involves arranging for a content provider (40) to communicate with a user device (30) and a broadcast service (50). The device (30) presents its user (20). The method involves: receiving user profile information from the user (20); receiving programme content indicative data (110) at the broadcast service (50); providing to the device (30) an a priori recording schedule (130) derived from the profile information (100) and the indicative data (110); receiving programme content (140, 150) at the broadcast service (50) and the device (30) and recording said received programme content at the device (30); analyzing the received programme content at the broadcast service (50) to generate an a posteriori selection schedule (200); receiving the selection schedule (200) at the device and processing the programme content recorded at the device (30) pursuant to the selection schedule (200) to generate the personalized programme content for the user (20).

The present invention relates to methods of providing personalized broadcast services. Moreover, the invention also relates to systems operable according to the methods. Furthermore, the invention relates to devices of the systems operable to execute the methods.

Earlier in the evolution of television broadcasting services, broadcasting organisations were responsible for arranging programme material, for example news reports and films, into a sequence for transmission to remote users by way of electromagnetic wave transmission. The users had no influence on content transmitted to them apart from exercising their choice of which television channel to watch and retuning programme ratings as feedback to the broadcasting organisations. Programme guides in printed form were available to assist the users select between available channels to watch programme material of personal preference to them. More recently, the availability of broadband fibre-optical communication services together with broader transmission bandwidths available from satellite communication systems has increased the choice of programme material that users can elect to receive and watch. In consequence, approaches to making selections of transmitted programme material have become an issue as the quantity of programme material available for reception has increased.

As a further evolution of such approaches, the concept of personal radio/TV broadcast has been appreciated and devices and associated services for allowing individual users or groups of users to receive shows that have been individually composed for them have been evolved. For example, in an international PCT patent application no. PCT/US00/23598 (WO 01/19084), there is described a system in which contributors such as individuals in their homes may create personal television channel programming. In the system, personal television programs may be distributed to multiple viewers over a communication network such as the Internet. Moreover, in the system, personal television program schedule information may be stored in a database that is also used to store programme schedule information for conventional television channels. Viewers are able to use a program guide or other interactive television application to view program schedule information, to set reminders, to set favorites, to establish parental control, and perform other such functions. Moreover, links may be provided from displayed personal television channels to web sites, chat rooms, e-mail applications, and other such features.

The inventors have envisaged that the concept of personal radio/TV broadcast comprises devices/services which are capable of allowing single users or groups of users to receive and view programme shows that have been individually composed for the users. However, although it is expected at some time in the future that there will be sufficient communication bandwidth available to transmit inexpensively full audio-visual content digitally on demand, there is perceived to be an intermediate stage in the nearer future during which there will be a demand for personalized services for which it will not be possible or too costly to transmit directly from service providers to remote user devices on an individual basis; such a situation represents a problem towards which the present invention is addressed.

An object of the invention is to provide a method of presenting a personalized broadcast service to users based on contemporary high-bandwidth communication infrastructure supplemented by additional relatively low-bandwidth communication channels.

According to a first aspect of the present invention, there is provided a method of providing a personalized broadcast service, characterized in that the method includes steps of:
(a) arranging for a content provider to be coupled in communication with one or more user devices and a broadcast service, the one or more user devices being operable to present personalized programme content to their respective one or more users;
(b) receiving at the broadcast service user profile information from the one or more users;
(c) receiving at the broadcast service programme content indicative data from the content provider;
(d) providing to the one or more devices an a priori recording schedule derived from at least one of the profile information and the programme content indicative data;
(e) receiving programme content at the broadcast service and the one or more user devices and recording said received programme content at the one or more user devices;
(f) analyzing the received programme content at the broadcast service to generate an a posteriori selection schedule;
(g) receiving the a posteriori selection schedule at the one or more user devices and processing the programme content recorded at the one or more user devices pursuant to the a posteriori selection schedule to generate the personalized programme content for presentation to the one or more users.

The invention is of advantage in that it is capable of providing a personalized broadcasting service based on contemporary communication infrastructure without needing to provide high-bandwidth communication paths from service providers individually to users.

Preferably, in the method, the programme content indicative data includes at least one of electronic programme guide (EPG) data and its associated meta data.

Preferably, in the method, the user profile information is communicated to the broadcast service by one or more of: via the one or more user devices, via a communication network such as the Internet, via a call centre, and by completion of one or more questionnaires at premises where the one or more user devices are initially purchased.

Preferably, in the method, the broadcast service is operable to construct the a priori recording schedule by processing a list of available and receivable stations, and EPG data including a corresponding list of temporally non-conflicting programmes.

Preferably, in the method, the broadcast service is operable to perform an analysis of programme content recorded thereat to generate the a posteriori selection schedule for communicating to the one or more user devices.

Preferably, in the method, the analysis utilizes at least one of: speech recognition, keyword spotting, topic detection, music genre classification, image analysis, video analysis.

Preferably, in the method, the broadcast service is operable to perform an analysis of user profile information to generate the a posteriori selection schedule for communicating to the one or more user devices. Use of user profile information is beneficial in creating a better tailored personal broadcasting service.

Preferably, in the method, the meta data includes parameters relating to at least one of: genre classification, topic information and summaries, subjective ratings.

Preferably, in the method, the programme content is arranged to be communicated from the content provider through relatively high bandwidth channels in step (e), and at least one of the user profile information in step (a), the programme content indicative data in step (b), the recording schedule in step (d) and the selection schedule in step (f) are arranged to be communicated through relatively low bandwidth channels. More preferably, in order to render the method capable of being implemented using contemporary communication links, the method is arranged such that:
(a) said relatively high bandwidth channels include one or more of satellite broadcast, terrestrial radio wave broadcast, wide-bandwidth optical fibre broadcast, broadband Internet; and
(b) said relatively low bandwidth channels include one or more of radio wave communication, radio telephony, lower bandwidth optical fibre.

Preferably, in the method, the user profile information stored at the broadcast service is capable of being updated in response to feedback from the one or more users.

According to a second aspect of the invention, there is provided a communication system for distributing personalized programme content operable according to the method of the first aspect of the invention.

According to a third aspect of the invention, there is provided a user device operable to function in the first aspect of the invention.

According to a fifth aspect of the invention, there is provided personalized programme data content generated according to the method of the first aspect of the invention.

It will be appreciated that features of the invention are susceptible to being combined in any combination without departing from the scope of the invention.

Embodiments of the invention will now be described, by way of example only, with reference to the following diagrams, wherein:

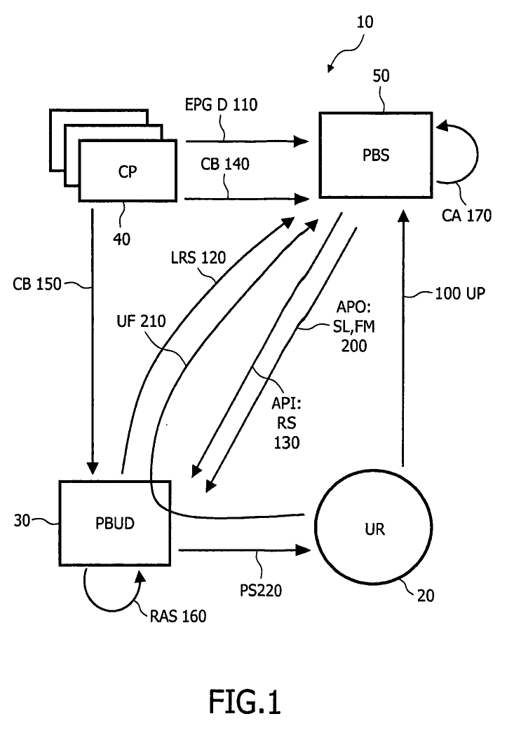

FIG. 1 is a diagram illustrating principal interactions between component parts of a system according to the invention; and

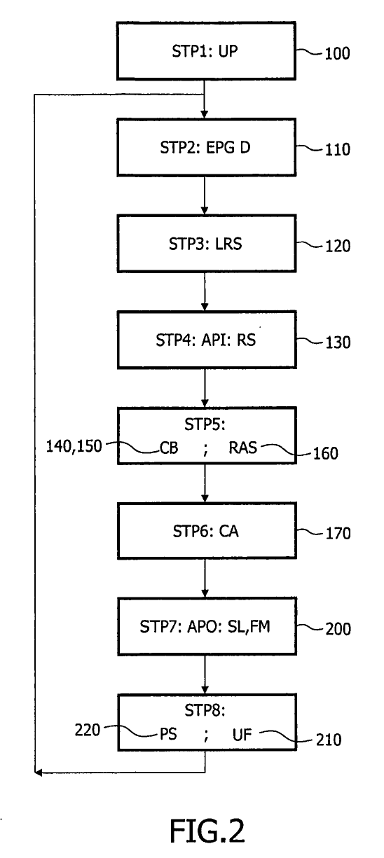

FIG. 2 is a flow chart of steps executed in a method according to the invention.

In the following description, there is described a solution which the inventors have devised to at least partially address the aforesaid problem of providing more personalized radio/TV broadcast. The present invention makes use of common non-personalized content delivery channels and a low bandwidth control channel between service provider and user's remote devices. Common delivery channels are to be construed to include broadcasts via satellite, cable broadcast and electromagnetic (airwave) transmissions.

Thus, the inventors have devised a method of providing a personalized broadcast service which involves several processing steps that can be implemented either on a service-provider side or on a user-side, for example at a user device. The processing steps include:
(S1) recording/storing programme content;
(S2) analyzing/classifying programme content;
(S3) selecting programme content based on user profiles;
(S4) compiling/scheduling selected programme content into individual user shows; and
(S5) updating user profiles in response to feedback/interaction between the service-provider and the user.

In a first configuration, it is envisaged that it is potentially feasible to implement the aforesaid processing steps (S1) to (S5) at the user's remote device, thereby potentially rendering the service provider obsolete in this respect. However, such a first configuration demands that the user's device is provided with a relative high storage capacity, with enough processing power for implementing real-time programme content classification, with a capability of implementing parallel multi-channel recording and also with support for a graphical interface for user profile generation.

Alternatively, in a second configuration, it is envisaged that it is potentially feasible to implement the aforesaid processing steps (S1) to (S5) at the service provider, namely to perform pre-processing steps and transmit a fully compiled show for each individual user for replay at the user's device. Such a second configuration allows for relatively inexpensive user devices but involves high individual communication loads from the service provider to its users. The second configuration will overload contemporary service providers' and users' servers and devices, especially in the case of mobile wireless devices on account of either physical or economic constraints.

In devising the present invention, the inventors have addressed communication bottlenecks which would arise in the aforesaid first and second configurations and therefore provide at least a partial solution in the case of contemporary and near-future communication infrastructure, namely to address device and service provider bandwidth limitations. The present invention utilizes distributed processing, especially when invoked in the context of audio/visual services.

It is known contemporarily to manually mark start/end times of commercial blocks, for example a group of advertisements arranged in sequence, in TV programmes, for example movies; such manually marked times are made available by private users via the Internet or similar communication network to other users. The manually marked times can be used for the automatic removal of commercial advertisements in digital recordings of movies. However, such dissemination of information does not anticipate principal features of personalized broadcast such as:
(a) automatic genre classification and/or key/word detection, especially when a server is not used for implementing classification labelling;
(b) scheduling of programme content, especially when rearrangement of programme and/or programme fragments are involved;
(c) profiling using user-specific information; and
(d) a priori components, especially with regard to generation and transmission of individual recording schedules.

Thus, such marking of start/end times does not constitute a personalized broadcast service as perceived by the inventors.

An existing service which is superficially related to the present invention is contemporary TiVo; TiVo concerns a digital video recorder providing up to 60 hours recording capacity. A user of TiVo is contacted via a telephone line for a provider of the TiVo service to provide to the user programming information for executing the following:
(1) for adjusting recording times in the case of line-up changes, namely programme content temporal transmission schedule changes;
(2) for recording every episode of a series, namely a “season pass”;
(3) automatic recording of record shows selected according to one or more parameters, for example one or more of favorite actor, director, team and topic.

In TiVo, the TiVo service provides user profiling aspects, in a manner akin to other recommendation systems, as well as an a priori schedule to user devices.

The present invention is distinguished from TiVo, amongst other features, on account of steps of:
(A) implementing a programme content analysis on service-provider side at recording time;
(B) generating a posteriori selection list; and
(C) providing for individual show scheduling.

In embodiments of the present invention, the inventors have appreciated that the aforementioned individual steps S1 to S5 are susceptible to being implemented between user devices of modest computing power and memory capacity, namely “small footprint devices”, and a powerful server provided at an associated service provider. The steps S1 to S5 are capable of being implemented with a minimum amount of communication load between the users and the service provider in such a configuration. Moreover, the inventors have devised an interaction protocol not requiring any substantial direct transmission of programme content data between the service provider and associated user devices.

In order to described an embodiment of the invention in more detail, reference will now be made to FIG. 1 which is a diagram illustrating principal interactions between component parts of a system according to the invention. The system is indicated generally by 10 and comprises at least one remote user device and a service provider coupled in communication with the at least one user. There is provided a relatively high bandwidth communication path for programme content from the service provider to the at least one user; by “high bandwidth” is meant bandwidth sufficient for conveying audio/visual programme content, whether in digital or analogue format. Moreover, there is also provided a relatively low bandwidth communication path for conveying user-generated control data from the at least one user to the service provider; by “low bandwidth” is meant bandwidth sufficient for conveying control data but insufficient for conveying significant amounts of programme content.

In FIG. 1, the system 10 includes a user (UR) 20, a personal broadcast user device (PBUD) 30, a programme content provider (CP) 40 and a personal broadcast service (PBS) 50. Interactions between the user 20, the device 30, the provider 40 and the service 50 are denoted by arrows which denote exchanges of information and/or data. Such exchanges are implemented according to a method of the invention which will now be described with reference to FIG. 1. In the following description, symbols S, D, C are employed to denote “service provider”, “user device” and “content provider” respectively.

In a first step (STP1) of the method, the user (UR) 20 transmits his/her profile to the service (PBS) 50, namely to a personal broadcast service provider S, Communication of the profile can be executed by one or more of: the user (UR) 20 employing the device (PBUD) 30, via a communication network such as the Internet, telephonically via a call centre, and by filling in a questionnaire in a retailing store/shop selling the device (PBUD) 30. The first step is denoted by user profile (UP) 100 in FIG. 1.

In a second step (STP2) of the method, the personal broadcast service (PBS) 50, namely S, obtains electronic programming guide (EPG) data from the programme content provider (CP) 40 or from external sources, for example Internet, about programmes that are to be broadcast in the near feature as well as meta data relating to entries in the EPG. The meta data preferably includes parameters such as genre classification, topic information and summaries, subjective ratings amongst other parameters. The second step is denoted in FIG. 1 by EPG data (EPG D) 110.

In a third step (STP3) of the method, the device (PBUD) 30, namely D, transmits a list of stations that it is able to receive to the personal service provider PBS 50. This list is preferably a sub-set of all stations potentially provided by the content provider (CP) 40, namely C. The third step is denoted by list of receivable stations (LRS) 120 in FIG. 1.

In a fourth step (STP4) of the method, the personal broadcast service (PBS) 50, namely S, constructs, on the basis of the user profile from the first step:
(a) the list of available and receivable stations; and
(b) the EPG data including a corresponding list of non-conflicting programmes comprising programme content that are most likely to comprise all material that will be needed to assembly an individual show for the user (UR) 20.

Such a corresponding list is termed “a priori recording schedule” which is transmitted to the device (PBUD) 30, namely to D. The fourth step is denoted by a priori recording schedule (API: RS) 130 in FIG. 1. This term “non-conflicting” relates to the ability of the user device (PBUD) 30 to receive one or more channels and record them simultaneously; for example, when the user device (PBUD) 30 is only capable of coping with one receiving channel, programme content sent to the user device (PBUD) 30 is arranged to be temporally non-overlapping. Preferably, the user profile (UP) 100 sent from the user (UR) 20 includes details of how many channels the user device (PBUD) 30 is capable of receiving and recording. When the user device (PBUD) 30 is capable of receiving and subsequently recording a plurality of channels simultaneously, it is potentially feasible to provide the user (UR) 20 with a more personalized customized broadcast service by selecting amongst temporally-overlapping programmes. A degree to which the user device (PBUD) 30 is capable of receiving multiple channels will depend upon hardware employed by the user device (PBUD) 30 and available communication infrastructure coupled to the user device (PBUD) 30. By including such channel details in the user profile (UP) 100 enables the system in FIG. 1 to adapt to upgrades in user device (PBUD) 30 hardware to receive more channels.

In a fifth step (STP5), both the device (PBUD) 30, namely D, and the personal broadcast service (PBS) 50, namely S, record all programmes or programme parts according to the a priori recording schedule established in the fourth step. This fifth step is denoted by content broadcast (CB) 140, 150 and also recording according to schedule (RAS) 160 in FIG. 1.

In a sixth step (STP6) of the method, the personal broadcast service 50, namely S, analyzes the recorded programmes from the fourth step. Such analysis may include many different processing steps, for example one or more of segmentation into fragments, speech recognition, keyword spotting, topic detection, music genre classification and so forth. The sixth step is denoted by content analysis (CA) 170 in FIG. 1.

In a seventh step (STP7) of the method, the personal broadcast service 50, namely S, compiles the personal show for the user (UR) 20 by combining suited content fragments according to the user's (UR) 20 profile provided in the first step and the show specifications, for example a desired total time duration of the show. A list of time stamps and programme identifiers, namely an a posteriori selection list, is sent to the device (PBUD) 30, namely to D, the list optionally including additional filler material. The filler material preferably relates to introduction and transition (between programmes) moderation, uniform resource locator (URL) links and additional content and/or music. The seventh step is denoted by an a posteriori selection list/filler material (APO: SL, FM) 200 in FIG. 1.

In an eighth step (STP8), the device (PBUD) 30, namely D, compiles the final personal show according to the a posteriori selection list of the seventh step by cutting and pasting its own recording of the required programmes; in other words, the device (PBLUD) 30 cuts and pastes recordings stored in memory situated at the (PBUD) device 30. The eight step is denoted by personal show (PS) 220 in FIG. 1. During or after playback of the show, the user (UR) 20 optionally provides feedback which is transmitted to the personal broadcast service (PBS) 50, namely to S, for updating the user profile as earlier provided in the first step; such optional feedback is denoted by user feedback (UF) 210 in FIG. 1.

The eight steps, namely STP1 to STP8, are illustrated in a temporal sequence in FIG. 2. It is to be noted that:
(a) the content provider (CP) 40 provides the programme content;
(b) the personal broadcast service (PBS) 50 structures a schedule for programme content customized for the user (UR) 20 in response to the user profile (UP) 100 and EPG data (EPG 110); and
(c) the device (PBUD) 30 is operable to receive, to subsequently process and finally arrange the programme content to generate the personal show for the user (UR) 20.

Thus, although the content provider 40 is susceptible to being implemented in a conventional manner, interaction between the broadcast service 50, the provider 40 and the device 30 as described in the foregoing renders the present invention distinguished from known personalized contemporary broadcast systems.

The present invention provides a benefit that it is capable of providing personal audio/visual broadcasts with a relatively small amount of effort and therefore lends itself to use in at least the near future. Moreover, the present invention does not require relatively large provision of processing power at the user device (PBUD) 30. Furthermore, a quantity of information exchanged between the content provider (CP) 40 and the broadcast service (PBS) 50 and the user device (PBUD) 30 is relatively small on account of substantial quantities of programme content being delivered from the content provider (CP) 40 to the broadcast service (PBS) 50 and the user device (PBUD) 30 via conventional established channels, for example airwaves and/or optical fibre cable. The present invention is thus susceptible to being implemented by suitably organizing and arranging substantially conventional technology.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of providing a personalized broadcast service, characterized in that the method includes steps of:
(a) arranging for a content provider (40) to be coupled in communication with one or more user devices (30) and a broadcast service (50), the one or more user devices (30) being operable to present personalized programme content to their respective one or more users (20);
(b) receiving at the broadcast service (50) user profile information (100) from the one or more users (20); (c) receiving at the broadcast service (50) programme content indicative data (110) from the content provider (40);
(d) providing to the one or more devices (30) an a priori recording schedule (130) derived from at least one of the profile information (100) and the programme content indicative data (110);
(e) receiving programme content (140, 150, 160) at the broadcast service and the one or more user devices (30) and recording said received programme content at the one or more user devices (30);
(f) analyzing the received programme content at the broadcast service (50) to generate an a posteriori selection schedule (200);
(g) receiving the a posteriori selection schedule (200) at the one or more user devices (30) and processing the programme content recorded at the one or more user devices (30) pursuant to the a posteriori selection schedule (200) to generate the personalized programme content for presentation to the one or more users (20).

2. A method according to claim 1, wherein the programme content indicative data (110) includes at least one of electronic programme guide (EPG) data and its associated meta data.

3. A method according to claim 1, wherein the user profile information (100) is communicated to the broadcast service (50) by one or more of: via the one or more user devices (30), via a communication network such as the Internet, via a call centre, and by completion of one or more questionnaires at premises where the one or more user devices (30) are initially purchased.

4. A method according to claim 1, wherein the broadcast service (50) is operable to construct the a priori recording schedule (130) by processing a list of available and receivable stations, and EPG data (110) including a corresponding list of temporally non-conflicting programmes.

5. A method according to claim 1, wherein the broadcast service (50) is operable to perform an analysis of programme content recorded thereat to generate the a posteriori selection schedule (200) for communicating to the one or more user devices (30).

6. A method according to claim 5, wherein the analysis utilizes at least one of: speech recognition, keyword spotting, topic detection, music genre classification, image analysis, video analysis.

7. A method according to claim 1, wherein the broadcast service (50) is operable to perform an analysis of user profile information to generate the a posteriori selection schedule (200) for communicating to the one or more user devices (30).

8. A method according to claim 2, wherein the meta data (110) includes parameters relating to at least one of: genre classification, topic information and summaries, subjective ratings.

9. A method according to claim 1 wherein the programme content is arranged to be communicated from the content provider (40) through relatively high bandwidth channels in step (e), and at least one of the user profile information (100) in step (a), the programme content indicative data (110) in step (b), the recording schedule (130) in step (d) and the selection schedule (200) in step (f) are arranged to be communicated through relatively low bandwidth channels.

10. A method according to claim 9, wherein:
(a) said relatively high bandwidth channels include one or more of satellite broadcast, terrestrial radio wave broadcast, wide-bandwidth optical fibre broadcast, broadband Internet; and
(b) said relatively low bandwidth channels include one or more of radio wave communication, radio telephony, lower bandwidth optical fibre.

11. A method according to claim 1, wherein the user profile information (100) stored at the broadcast service (50) is capable of being updated in response to feedback from the one or more users (20).

12. A communication system for distributing personalized programme content operable according to the method of claim 1.

13. A user device (30) operable to function according to the method of claim 1.

14. Personalized programme data content (220) generated according to the method of claim 1.
